(19) United States
(12) Patent Application Publication
(10) Pub. No.: US 2004/0173099 A1
(43) Pub. Date: Sep. 9, 2004

(54) Filter device for an exhauster hood

(75) Inventors: Wilfried Ruckert, Walzbachtal (DE); Dietrich Schmid, Ehningen (DE); Dieter Rosmann, Stuttgart (DE)

Correspondence Address: John T. Winburn, BSH Home Appliances Corporation, 100 Bosch Blvd, New Bern, NC, 28562, US

(73) Assignee: BSH Bosch und Siemens Hausgerate GmbH, Munich (DE)

(21) Appl. No.: 10/771,670

(22) Filed: Feb. 4, 2004

(30) Foreign Application Priority Data
Aug. 7, 2001 (DE) 10137932.3
Aug. 7, 2002 (WO) WO 03/013693 A1
Aug. 7, 2002 (WO) PCT/EP02/08842

(51) Int. Cl. B01D 53/02

(52) U.S. Cl. 96/108

(57) ABSTRACT

A filter device for an exhaust hood including a plurality of adjacent chambers limited by wall-shaped elements and formed in a flat array. A sorbent in the chambers for absorbing sorbents in air flowing transversely through the array. At least one element formed in a convex and/or convex shape in cross-section in the direction of air flow in order to deflect air downstream of the filter device.

The present invention relates to a filter device for an exhauster hood in accordance with the type defined in greater detail in the preamble of Claim 1.

DE 31 46 537 C1 discloses a filter for an exhauster hood with an active carbon filter. This active carbon filter has a flat, substantially horizontal frame, whereof the interior is subdivided by inclined walls into a plurality of chambers open to both sides, which are filled with active carbon and are closed on both sides by covers permeable to air. The walls dividing the interior of the frame into chambers are in each case arranged at an incline in the direction of a suction axis of the exhauster hood.

In addition, the walls having increasing distance from the suction axis exhibit an increasing angle of inclination relative to the suction axis, so that fumes exhausted substantially vertically to the frame surface of the active carbon filter is deflected to the walls and a greater bulk density must flow through than would be the case with fully vertical passage.

But the disadvantage here is that air or cooking fumes exhausted via a suction device of the exhauster hood will first collide with the inclined walls and along the walls in the direction of the suction device via the bulk material, or be guided by the active carbon, which is why the flow of the cooking fumes is impaired undesirably. The exhausted air is abruptly braked on impact and when deflected, which is why a higher rating of the suction device of the exhauster hood is required for a desired suction output, and the consequence of the flow resistance is disruptive noise increase during operation of the exhauster hood.

The object of the invention is to design a filter device for an exhauster hood of the type specified in the preamble of Claim 1, such that good suction output is achieved with minimal rating increase, and any noise increase during operation of the exhauster hood is minimal.

This object is solved according to the present invention by the characteristics specified in Claim 1.

The result of at least one element in the direction of flow of the cooking fumes being designed convex and or concave is that the cooking fumes exhausted substantially vertically to the exhauster hood are diverted on the elements harmoniously, i.e. without greater flow or output losses. In addition, a greater bulk density of the sorbent is flowed through and a drop in output or a drop in the flow rate of the exhausted cooking fumes is considerably less than is the case with elements known from the prior art, only inclined and designed straight in cross-section.

The filter device for an exhauster hood according to the present invention advantageously has better efficiency than the solutions known from the prior art, because the flow of the exhausted quantity of air or cooking fumes is essentially more harmonious through convex designing of the elements or the chamber connectors, by which a suction device assigned to the exhauster hood can be operated with minimal suction output.

Further to this, it is an advantage that through harmonious flow of the cooking fumes in the exhauster hood noise developing due to the minimal disturbance of the flow of cooking fumes inside the exhauster hood is reduced and noise level in the region of a cooking site or the like can be kept to a minimum.

Advantageous embodiments of the invention form the objects of the sub-claims.

In an advantageous configuration of the elements there is provision to design the latter in cross-section at least approximately parabolic, resulting in a particularly harmonious flow of the exhausted cooking fumes. A vertex of the parabola is arranged on the side of the elements facing a cooking site, so that air flowing into the exhauster hood is first diverted more strongly and travels a longer flow path in the filter medium or sorbent. With an increasing flow path diversion becomes weaker, so that the flow resistance is less.

In another advantageous embodiment of the element there is provision to design the latter at least approximately as a hyperboloid, with which the element acts as an inlet nozzle for the exhausted cooking fumes and the flow resistances are low, as desired.

In order to guarantee a harmonious flow characterised by minimal flow resistances in the outer edge regions of the exhauster hood, it is provided in another advantageous embodiment of the invention to arrange the elements running radially from inside out. The result of this is that areas of the exhauster hood, which are further removed from the suction centre of the suction device, have a greater flow cross-section than those areas assigned closer to the suction device. This structural measure leads advantageously to additional reduction of the flow resistances.

For precise positioning of the struts and fixing the struts it can be provided to attach the latter to one another via struts. The elements also form a pre-fabricated structural unit, which can be inserted or incorporated in the latter with assembly of the exhauster hood without greater assembly expenditure.

With the element being designed as inlet nozzle for a suction device arranged downstream, the flow resistance of the filter device and thus also the noise factor are diminished.

Further characteristics and advantages of the invention will emerge from the following description of embodiments with respect to the attached figures, in which:

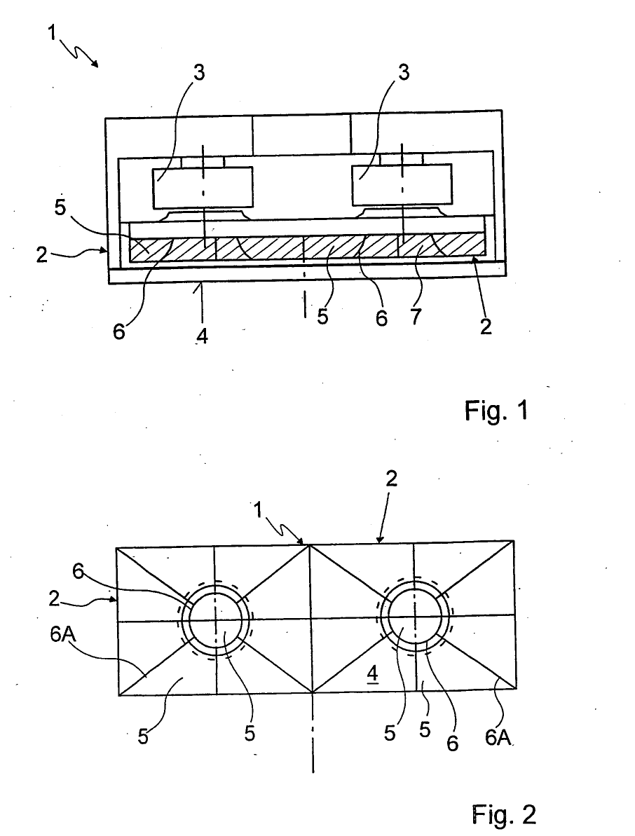

FIG. 1 is a schematic section through the exhauster hood, whereby a filter device is designed rectangular;

FIG. 2 is an underneath view of the exhauster hood as per FIG. 1;

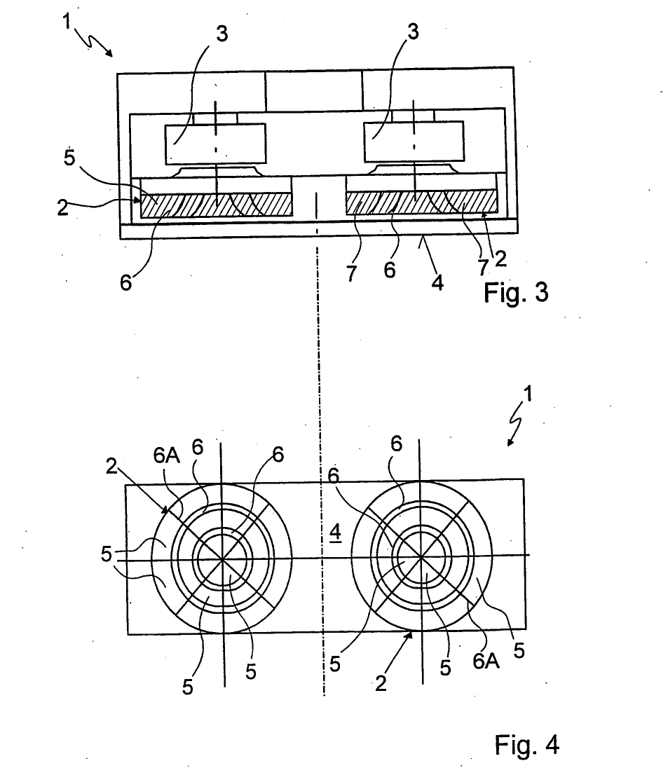

FIG. 3 is a schematic section through another embodiment of a fume exhaust hood, whereby the filter device is designed circular, and

FIG. 4 is an underneath view of the exhauster hood as per FIG. 3.

FIG. 1 illustrates a schematic longitudinal section through an exhauster hood 1 with a filter device 2 and a suction device 3. The exhauster hood 1 is arranged above a cooking site, not shown here in greater detail, whereby on its side facing the cooking site the exhauster hood 1 is provided with an inlet opening 4 for suctioning cooking fumes extending over the entire width of the exhauster hood 1. On the side of the exhauster hood 1 averted from the inlet opening 4 the air cleaned of cooking fumes and aerosols is given off as waste air or as circulating air to the environment, or drawn off from the cooking site via an exhaust air system, not shown here in greater detail. In the process the exhaust air system can be configured as a pipeline system.

In the present embodiment the filter device 2 is divided via several wall-shaped elements 6 into various chambers 5, which are designed open for throughflow at their sides both facing and averted from the inlet opening 4. The chambers 5 of the filter device 2 are provided with a sorbent 7 for absorbing sorbents, such as for example cooking fumes and/or aerosols, from exhausted air. In the case of the sorbent 7 this is mostly active carbon, on the surface of which the sorbents found in the exhausted air accumulate adsorptively.

In the opinion of the expert suitable sorbents other than active carbon in the filter device 2, such as e.g. Flies or the like, can be provided so that the sorbents are filtered from the contaminated air also by means of absorption, that is, they are filtered therefrom using an additional volumetric filtering process.

The elements 6 provided for configuring the individual chambers 5 are designed convex or bent in cross-section in the direction of flow of the cooking fumes or the contaminated air, resulting in a harmonious flow in the exhauster hood 1 or the filter device 2, such that air flowing in on the inflow side of the filter device 2 is diverted harmoniously or without a jerk by means of the bent elements 6 inside the filter device 2 after it exits from the outflow side of the filter device in the direction of the suction device 3. And, a greater flow path in the sorbent 7 or the bulk material is achieved through the convex configuration of the elements 6, resulting in higher cleaning efficiency of the filter device 2.

It is apparent from the underneath view of the exhauster hood 1 shown in FIG. 2 in combination with the illustration of FIG. 1 that the elements 6 are designed partially as hyperboloids, and from a type of inlet nozzle for the exhausted air. The individual chambers 5 of the filter device 2 are formed by additional radially arranged elements 6A.

The exhauster hood 1 according to FIGS. 1 and 2 is fitted with two filter devices 2 and two assigned suction devices 3, which is why the exhauster hood 1 is also suitable for larger cooking sites and edge regions of the exhauster hood 1 are fitted with adequate suction piping.

FIG. 3 illustrates another embodiment of an exhauster hood 1, whereby as illustrated in greater detail in FIG. 4, the filter device 2 is configured circular. The elements 6 are here likewise designed arc-like or convex in cross-section and due to their circular configuration in each case form hyperboloids, resulting in an extremely effective and harmonious flow in the filter device 2 or the sorbent 7. The greatest possible flow path of exhausted contaminated air from the cooking site is guaranteed in the sorbent 5 with the least possible hindrance to the flow in the exhauster hood 1.

The individual chambers 6 are designed pie-shaped by the hyperbolically configured elements 7 and the radially arranged other elements 6A, resulting in the outer areas of the exhauster hood 1 or its chambers 5 having larger flow cross-sections.

The radially arranged elements 6A constitute connecting braces for the convex elements 6, whereby the filter device 2 is a fixed, pre-assembled structural unit and can be easily inserted and affixed in the latter during assembly of the exhauster hood 1.

The suction device 3 of the exhauster hood 1 is designed as a ventilator unit integrated in a manner known per se into the exhauster hood, whereby it is up the expert to realise the suction device in another suitable form deviating therefrom. In addition it is also possible to position the suction device externally, i.e. outside the exhauster hood. At the same time there is the option of designing the exhauster hood with less height and to assign one suction device to several exhauster hoods, such as for example in a large kitchen.

Alternatively, the elements 6 designed convex in cross-section in the direction of flow can also be designed concave or convex and/or concave in cross-section in direction of flow.

The above described exhauster hood can also be made available for other applications, such as for example as an exhaust and cleaning unit for laboratories or the like, to free contaminated air of harmful sorbents.

1. A filter device for an exhauster hood (1), which has several adjacently arranged chambers (5), limited by wall-shaped elements (6), resulting in a flat array, whereby a sorbent (7) for absorbing sorbents from air, flowing transversely through the flat array is provided in the chambers (5), characterised in that at least one element (6) is designed convex and/or concave in cross-section in the direction of air flow.

2. The filter device as claimed in claim 1, characterised in that the element (6) is designed parabolic in cross-section, whereby a vertex is arranged on the side of the element (6) facing a cooking site.

3. The filter device as claimed in claim 1 or 2, characterised in that the element (6) is designed at least approximately as a hyperboloid.

4. The filter device as claimed in any one of claims 1 to 3, characterised in that at least a part of the elements (6A) is arranged radially.

5. The filter device as claimed in any one of claims 1 to 4, characterised in that the elements (6, 6A) are connected solidly at least partially to one another.

6. The filter device as claimed in any one of claims 1 to 5, characterised in that the element (6) is designed as an inlet nozzle for a suction device (3) arranged downstream.
